(19) United States
(12) Patent Application Publication
(10) Pub. No.: US 2012/0285948 A1
(43) Pub. Date: Nov. 15, 2012

(54) SYSTEM AND METHOD FOR DETECTING VESSEL PRESENCE AND CIRCUIT RESONANCE FOR AN INDUCTION HEATING APPARATUS

(75) Inventors: Mingwei Shan, Louisville, KY (US); Daniel Vincent Brosnan, Louisville, KY (US); Gregory Francis Gawron, SR., Jeffersontown, KY (US); John Michael Kulp, JR., Louisville, KY (US); Eric K. Watson, Louisville, KY (US)

(73) Assignee: GENERAL ELECTRIC COMPANY, Schenectady, NY (US)

(21) Appl. No.: 13/104,195

(22) Filed: May 10, 2011

(51) Int. Cl. H05B 6/04

(52) U.S. Cl. 219/660

(57) ABSTRACT

Systems and methods for detecting vessel presence and circuit resonance for an induction heating apparatus are disclosed. A detector circuit generates an output signal based on a feedback signal corresponding to a signal, such as current, flowing through an induction heating coil. The output signal has a duty cycle corresponding to the proximity of operating frequency of the induction heating apparatus to resonance. Changes in the duty cycle of the output signal can be monitored to determine the presence or absence of a vessel on the induction heating coil.

### FIELD OF THE INVENTION

The present disclosure relates to induction heating and more particularly to a system and method for resonant detection and control for an induction heating apparatus, such as a cooktop.

### BACKGROUND OF THE INVENTION

Induction cooktops are used to heat cooking utensils by magnetic induction. A resonant power inverter can be used to supply a chopped DC power signal through a heating coil. This generates a magnetic field, which is magnetically coupled to a conductive object or vessel, such as a pan, placed over the heating coil. The magnetic field generates eddy currents in the vessel, causing the vessel to heat.

A typical resonant power inverter circuit is illustrated in FIG. 1. As shown, the induction heating coil 114 receives a power signal 101 that is supplied through a resonant power inverter, referred to herein as a resonant inverter module 112. The resonant inverter module 112 is generally configured to generate a high frequency power signal from power supply 101 at the required operating frequency to the induction heating coil 114. The load of the resonant inverter module 112 generally includes the induction heating coil 114 and any object or vessel that is present on the induction heating coil 114. The object or vessel on the induction heating coil 114, such as for example a pan, will be generally referred to herein as a vessel.

The resonant inverter module 112 is coupled to AC source 108. The resonant inverter module 112 is provided with switching devices Q1 and Q2, which provide power to the load, including the induction heating coil 114 and any vessel or object thereon. The direction A, B of the current flow through the induction heating coil 114 is controlled by the switching of transistors Q1 and Q2. Switching unit 130 provides the controlled switching of the switching devices Q1, Q2 based on a switching control signal provided from controller 120. In typical known applications, controller 120 can be configured to control switching unit 130 based on signals from a current transducer or current transformer 110.

Switching devices Q1 and Q2 can be insulated-gate bipolar transistors (IGBTs) and the switching unit 130 can be a Pulse Width Modulation (PWM) controlled half bridge gate driver integrated circuit. In alternate embodiments, any suitable switching devices can be used, other than IGBTs. Snubber capacitors C2, C3 and resonant capacitors C4, C5 are connected between a positive power terminal and a negative power terminal to successively resonate with the induction heating coil 114. The induction heating coil 114 is connected between the switching devices Q1, Q2 and induces an eddy current in the vessel (not shown) located on or near the induction heating coil 114. In particular, the generated resonant currents induce a magnetic field coupled to the vessel, inducing eddy currents in the vessel. The eddy currents heat the vessel on the induction heating coil 114 as is generally understood in the art.

The resonant inverter module 112 powers the induction heating coil 114 with high frequency current. The switching of the switching devices Q1 and Q2 by switching unit 130 controls the direction A, B and frequency of this current. In one embodiment, this switching occurs at a switching frequency in a range that is between approximately 20 kHz to 50 kHz. When the cycle of the switching control signal from the switching unit 130 is at a high state, switching device Q1 is switched ON and switching device Q2 is switched OFF. When the cycle of the switching control signal is at a low state, switching device Q2 is switched ON and switching device Q1 is switched OFF. When switching device Q1 is triggered on, a positive voltage is applied to the coil and the current of the power signal 101 flows through the induction heating coil 114 in the direction of B initially and then transitions to the A direction. When switching device Q2 is triggered on, a negative voltage is applied to the coil and the current of the power signal 101 flows through the induction heating coil 114 in direction of A initially and then transitions to the B direction.

If switching device Q1 is turned on and switching device Q2 is turned off, the resonance capacitor C5 and the induction coil 114 (including any vessel thereon) form a resonant circuit. If the switching device Q1 is turned off and switching device Q2 is turned on, the resonance capacitor C4 and the induction coil 114 (including any vessel thereon) form the resonant circuit.

To properly drive an induction coil using a resonant power inverter, such as the resonant power inverter depicted in FIG. 1, it is important to have an accurate assessment of the resonant frequency of the resonant power inverter being used to drive the induction coil. In particular, the output power of the induction coil is a function of the input, the coil inductance, vessel resistance and resonant frequency of the system. The closer the system is driven to resonant frequency, the more power can be delivered to the system. Maximum output occurs at resonance and subsequently lower power levels are driven away from resonance accordingly.

It is advantageous to operate the resonant power inverter at resonance or above resonance for many reasons. For instance, operating at resonance provides maximum power transfer between the induction heating coil and the vessel on the induction heating coil. If reduced power on the induction heating coil is desired, it is advantageous to drive the frequency above resonance. Operating below resonance results in greater switching losses, leading to reduced efficiency. Moreover, operating below resonance risks entering into the human audible hearing range, leading to undesirable operating conditions.

FIG. 2 provides a graphical depiction of the desirable operating range for a resonant power inverter for supplying chopped DC power to an induction heating coil. As indicated by curve 200, maximum power is achieved at resonant frequency. Reduced power occurs at frequencies further from the resonant frequency. FIG. 2 illustrates that the desired operating range is at or above the resonant frequency for the resonant power inverter. Dropping below resonant frequency can lead to inefficient operation of the resonant power circuit, as well as entering into the human audible hearing range.

There are multiple methods of object or vessel detection on an induction cooktop and for detecting the resonant frequency of a resonant power inverter. Some of these include mechanical switching, phase detection, optical sensing and harmonic distortion sensing. In some systems, these detection methods typically use a current transformer to detect the resonant voltage. When the system is operating at resonance, optimal power transfer between the induction heating coil and the object on the induction heating coil will occur. However, a current transformer will typically provide a sine or triangle like wave of power output to the induction heating coil, whether the system is operating in resonance or non-resonance. The alternating nature of the output signal produced by the current transformer is not dependent upon resonance and there will be little to no distortion due to switching. In addition, current transducers will yield an inconsistent and inaccurate output over a frequency range due to transformer loss principles. Furthermore, current transformer packages tend to have large package sizes and footprints, and can be expensive.

Thus, a need exists for system and method for circuit resonant detection and control for an induction heating apparatus that overcomes the above mentioned disadvantages. A system and method that could additionally provide for vessel presence detection would be particularly useful.

### BRIEF DESCRIPTION OF THE INVENTION

Aspects and advantages of the invention will be set forth in part in the following description, or may be obvious from the description, or may be learned through practice of the invention.

One exemplary embodiment of the present disclosure is directed to an induction heating system. The system includes an induction heating coil operable to heat a load with a magnetic field and a power supply circuit configured to supply a power signal to the induction heating coil at an operating frequency. The system further includes a detector circuit configured to detect a feedback signal corresponding to a signal, such as current, flowing through the induction heating coil. The detector circuit provides an output signal having a duty cycle. The duty cycle of the output signal is based at least in part on a percentage of the feedback signal that is greater or less than a reference signal. The duty cycle of the output signal corresponds to the proximity of the operating frequency of the power supply circuit to resonance of the induction heating system.

Another exemplary embodiment of the present disclosure is directed to a method. The method includes detecting a feedback signal in an induction heating apparatus. The feedback signal corresponds to a signal flow through an induction heating coil of the induction heating apparatus. The method further includes comparing the feedback signal to a reference signal to generate an output signal having a duty cycle. The duty cycle of the output signal is based at least in part on a percentage of the feedback signal that is greater or less than the reference signal. The duty cycle of the output signal corresponds to the proximity of an operating frequency of the induction heating apparatus to resonance.

A further exemplary embodiment of the present disclosure is directed to an induction heating system. The induction heating system includes an induction heating coil operable to inductively heat a load with a magnetic field. The induction heating system further includes an inverter circuit configured to supply a chopped DC power signal to the induction heating coil at an operating frequency. The inverter circuit includes a plurality of switching devices configured to control the direction of current through the induction heating coil. The induction heating system further includes a detector circuit configured to detect a feedback signal corresponding to a signal flowing through the induction heating coil. The detector circuit provides an output signal having a duty cycle based at least in part on a percentage of the feedback signal that has a magnitude greater or less than the reference signal. The induction heating system further includes a controller configured to control the switching devices of the inverter circuit based at least in part on the duty cycle of the output signal of the detector circuit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a circuit diagram of a typical known resonant power inverter circuit for supplying power to an induction heating coil;

FIG. 2 provides a graphical depiction of the desirable operating range for a resonant power inverter for supplying power to an induction heating coil;

FIG. 3 provides a block diagram of an induction heating system according to an exemplary embodiment of the present disclosure;

FIG. 4 provides a circuit diagram of an induction heating system according to an exemplary embodiment of the present disclosure;

FIG. 5 provides a graphical depiction of feedback signal across a shunt resistor in a return path of the current flowing through an induction heating coil at an operating frequency above resonance according to an exemplary embodiment of the present disclosure;

FIG. 6 provides a graphical depiction of feedback signal across a shunt resistor in a return path of the current flowing through an induction heating coil at an operating frequency at or close to resonance according to an exemplary embodiment of the present disclosure;

FIG. 7 provides a flow diagram of an exemplary method according to an exemplary embodiment of the present disclosure;

FIG. 8 provides a flow diagram of an exemplary method according to an exemplary embodiment of the present disclosure;

FIG. 9 provides a flow diagram of an exemplary method according to an exemplary embodiment of the present disclosure; and

FIGS. 10-13 provide graphical depictions of output signals of a detection circuit according to an exemplary embodiment of the present disclosure

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for circuit resonant detection and control for an induction heating apparatus. As proximity to resonance is monitored, the system can adjust accordingly to provide the most desirable operation of the induction heating apparatus, such as at best efficiency, at maximum power, at lesser desired power, at less electromagnetic or induced audio noise, etc. The present subject matter monitors a duty cycle of a feedback signal that is particularly suitable for use in conjunction with a shunt resistor coupled to the induction heating apparatus. The duty cycle of the feedback signal provides an indication of the proximity of the operating frequency of the induction heating apparatus to resonance. In addition, changes in the duty cycle can be monitored to determine the presence of a vessel on the induction heating apparatus.

The systems and methods of the present disclosure are described with reference to an induction cooking apparatus. Those of ordinary skill in the art, using the disclosures provided herein, should understand that the systems and methods of the present disclosure are more broadly applicable to many resonant power supply technologies.

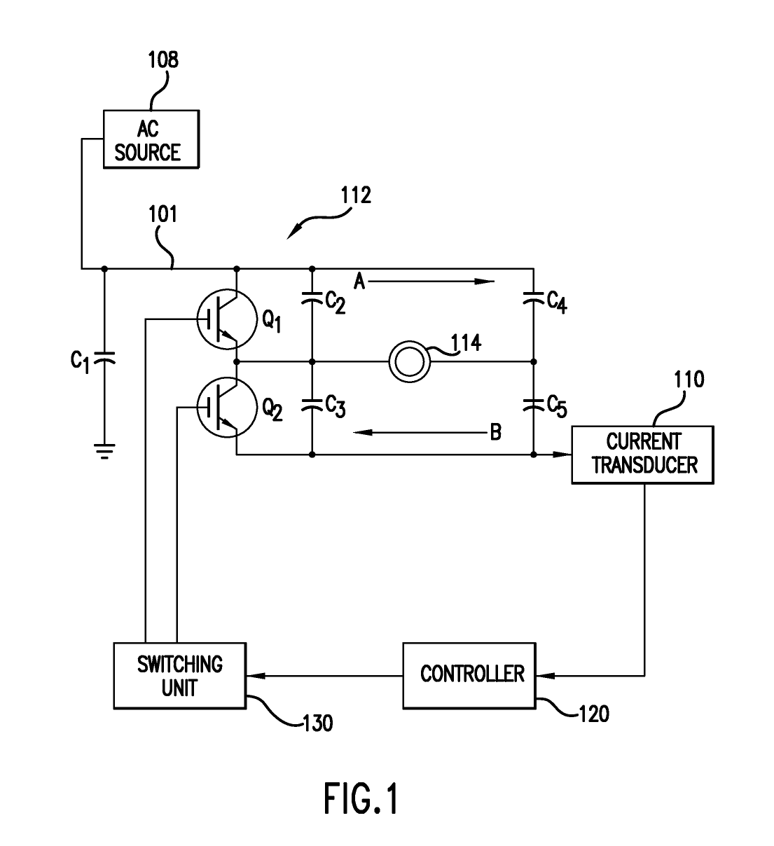

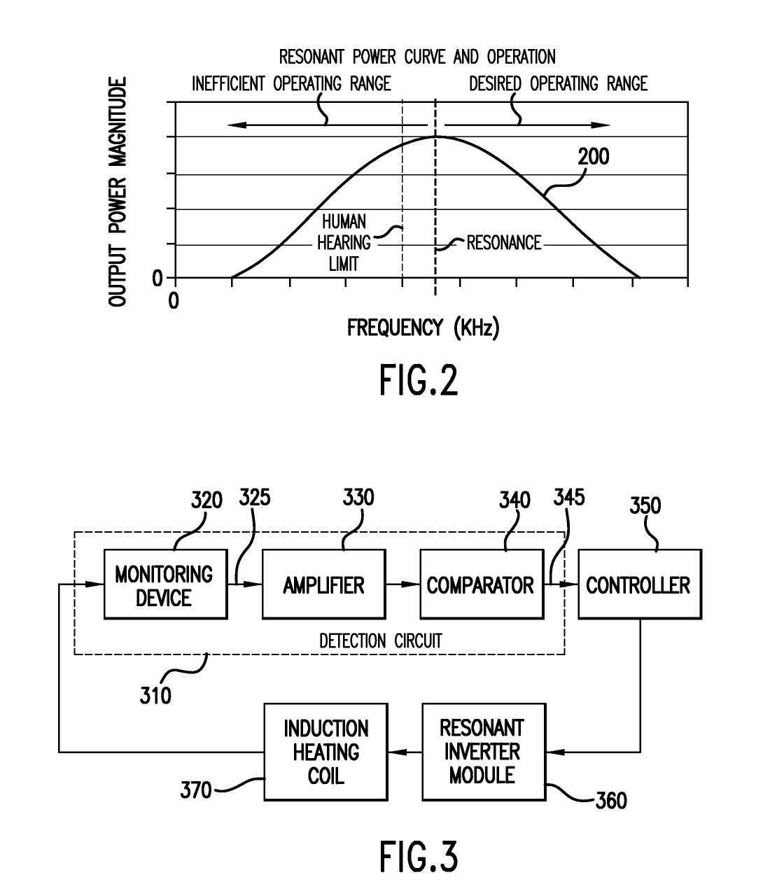

FIG. 3 is a schematic block diagram of an induction heating system 300 according to an exemplary embodiment of the present disclosure. The induction heating system 300 includes a detection circuit 310, a controller 350, a power supply circuit such as resonant inverter module 360, and an induction heating coil 370. The resonant inverter module 360 is configured to supply a chopped DC power signal to induction heating coil 370 at a desired operating frequency. The topology of the resonant inverter module 360 can be similar to the known resonant inverter topology depicted in FIG. 1.

Referring still to FIG. 3, the detection circuit 310 can include a monitoring device 320 that is configured to detect and measure a current flow through induction heating coil 370. The monitoring device 320 generates a feedback signal 325 based on the current flow through the induction heating coil 370. The feedback signal 325 can be amplified at amplifier 330 and provided to comparator 340. Those of ordinary skill in the art, using the disclosures provided herein, will understand that other signal conditioning devices, such as filters, shifters, etc., can be used to condition the feedback signal for processing.

Comparator 340 is configured to compare the feedback signal 325 with a reference signal to generate an output signal 345 that is provided to controller 350. The output signal 345 has a duty cycle that is based on the percentage of the feedback signal 325 that is greater or less than the reference signal for one period of the feedback signal 325. As will be discussed in more detail below, the duty cycle of the output signal 345 provides information to the controller 350 concerning the proximity of the operating frequency of the induction heating system 300 to resonance.

The controller 350 can be configured to control the resonant inverter module 360 based at least in part on the duty cycle of the output signal 345 of the detection circuit 310. For instance, in a particular embodiment, the controller 350 can be configured to determine the resonant frequency of the induction heating system 300 and adjust the operating frequency of the resonant power inverter 360 to provide maximum power or less power as desired. In another embodiment, controller 350 can detect the presence of a vessel on the induction heating coil 370 by monitoring changes in the duty cycle of the output signal 240.

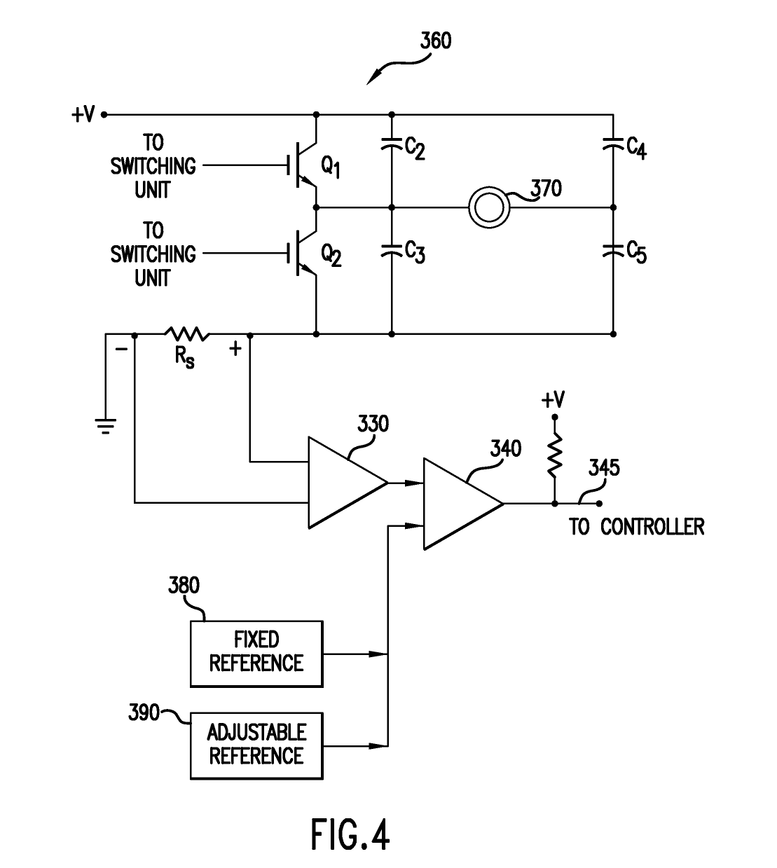

FIG. 4 illustrates a circuit diagram of an exemplary induction heating system 300 that monitors a feedback signal across a shunt resistor Rs in a return path of the current flowing through an induction heating coil 370. As shown, the system 300 includes a resonant inverter module 360 configured to supply a chopped DC power signal to induction heating coil 370. The resonant inverter module 360 has a topology similar to the known resonant inverter module 112 depicted in FIG. 1. As illustrated, switching devices Q1 and Q2 can be controlled by a switching unit to provide chopped DC power to induction heating coil 370.

The system 300 includes a shunt resistor Rs in a return path of the current flowing through the induction heating coil 370. The feedback signal 325 for the induction heating system 300 can include the voltage across the shunt resistor Rs.

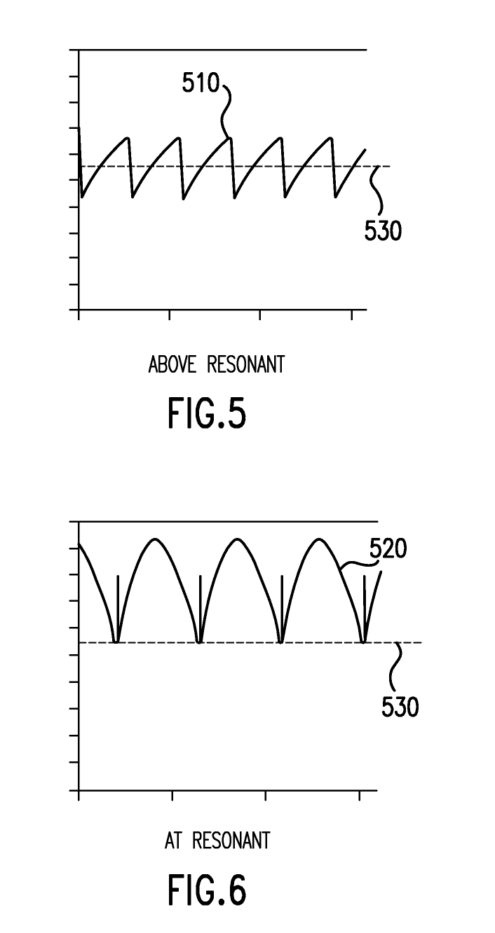

FIG. 5 illustrates an exemplary plot of a feedback signal 325 across the shunt resistor Rs at an operating frequency above resonance. As illustrated by curve 510, the feedback signal looks purely reactive at operating frequencies above resonance in that there is the same amount of signal above and below the reference line 530 (OA line).

FIG. 6 illustrates an exemplary plot of a feedback signal 325 across the shunt resistor Rs at an operating frequency at or close to resonance. As shown by curve 520, the signal begins to look purely real when the system 300 is operating near resonance and the entire wave form is located above the reference line 530. In this regard, the proximity of the frequency to resonance can be monitored by monitoring the duty cycle of the feedback signal across shunt resistor Rs. The duty cycle provides a measure of the percentage of feedback signal that is above or below the reference line for one period of the feedback signal.

Referring back to FIG. 4, the voltage across Rs can be provided to an amplifier 330 configured to amplify the feedback signal 325. Those of ordinary skill in the art, using the disclosures provided herein, should understand that the feedback signal 325 can provided to other signal conditioning devices as desired.

The output of the amplifier 330 provides an input to the comparator 340. Comparator 340 compares the amplified feedback signal to a reference signal. The reference signal can be either a fixed reference 380 or an adjustable reference 390. The adjustable reference 390 allows the detection circuit to be adjusted to compensate for noise and/or other system offsets.

The output signal 345 of the comparator 340 will have a duty cycle based on the percentage of the feedback signal that is above or below the reference signal, depending on the configuration of the comparator 340. For instance, in a particular implementation, the output signal 345 has a duty cycle that is based on a percentage of the feedback signal that is above the reference signal. In another particular implementation, the output signal 345 has a duty cycle that is based on a percentage of the feedback signal that is below the reference signal.

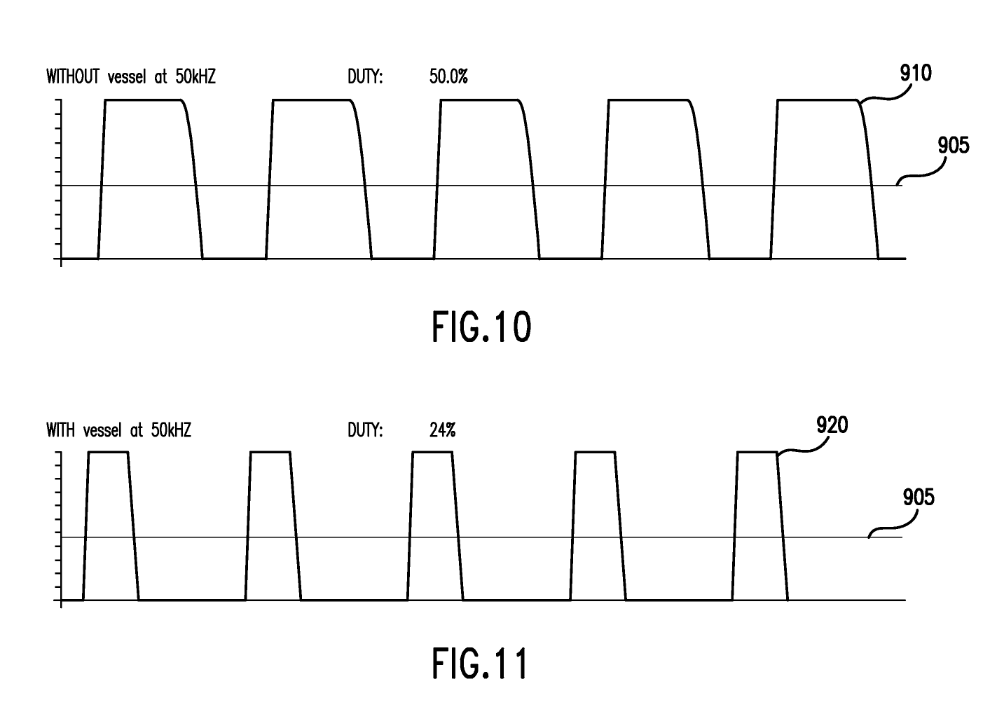

FIGS. 10-13 provide graphical depictions of an output signal 345 at varying operating frequencies and at varying loads on the induction heating coil 370. FIG. 10 depicts a graphical representation of an output signal 910 at an operating frequency of about 50 kHz and with no vessel located on the induction heating coil 370. As illustrated, approximately 50% of the output signal 910 is above the reference line 905. This indicates that the feedback signal is greater or less (depending on the configuration of the comparator) than the reference signal for approximately 50% of the cycle for one period. The output signal 910 therefore has a duty cycle of 50%. A duty cycle of 50% provides an indication that the induction heating system is operating at a frequency that is well above or well below resonance.

FIG. 11 provides a graphical representation of an output signal 920 at an operating frequency of about 50 kHz but with a vessel located on the induction heating coil 370. As illustrated, approximately 24% of the output signal is above the reference line 905. This indicates that the feedback signal is greater or less (depending on the configuration of the comparator) than the reference signal for approximately 24% of the cycle for one period. The output signal 920 therefore has a duty cycle of 24%. The approximately 26% change in duty cycle from output signal 910 to output signal 920 occurs due to the placement of a vessel on the induction heating coil 370. The placement of the vessel on the induction heating coil 370 alters the resonant frequency of the system such that the 50 kHz operating frequency is closer to resonance. Because the placement of the vessel on the induction heating coil resulted in a significant change in the duty cycle of the output signal, changes in the duty cycle of the output signal can be monitored to determine the presence or absence of a vessel on the induction heating coil 370.

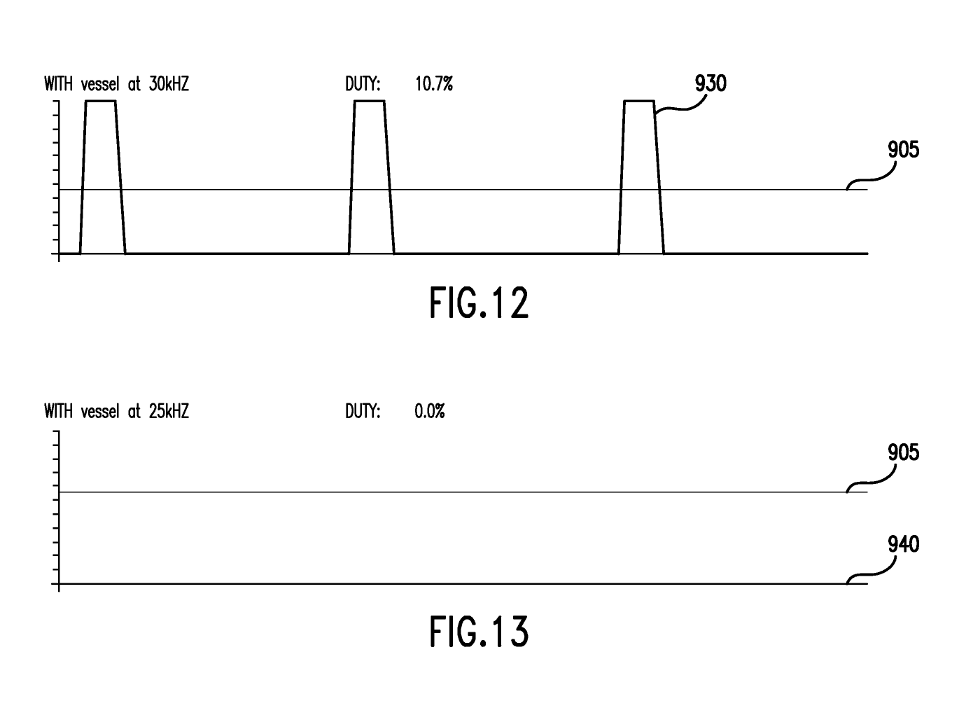

FIG. 12 provides a graphical representation of an output signal 930 at an operating frequency of about 30 kHz with a vessel located on the induction heating coil. As illustrated, approximately 10.7% of the output signal 930 is above the reference line. This indicates that the feedback signal is greater or less (depending on the configuration of the comparator) than the reference signal for approximately 10.7% of the cycle for one period. The output signal 930 therefore has a duty cycle of 10.7%. The lower duty cycle of 10.7% indicates that the operating frequency is closer to resonance.

FIG. 13 provides a graphical representation of an output signal 940 at an operating frequency of about 25 kHz with a vessel located on the induction heating coil 370. As illustrated, the entire output signal 940 is located below the reference line 905. This indicates that the feedback signal is always greater or less (depending on the configuration of the comparator) than the reference signal for an entire cycle. The duty cycle of the output signal 940 is about 0%, indicating the system is operating close to or at resonance. As demonstrated by the various output signals set forth in FIGS. 10-13, the proximity of a resonant induction system to resonance can be monitored by monitoring the duty cycle of the output signal.

Determining proximity to resonance by monitoring a feedback signal across a shunt resistor in line with an induction heating coil as illustrated in FIG. 4 provides numerous advantages. First, the voltage across the shunt resistor Rs provides a reliable feedback signal with a good signal-to-noise ratio. Second, the duty cycle of the output signal is not particularly sensitive to current feedback noise, providing for more robust control. Finally, vessel presence detection and resonance detection can be provided with one output signal, namely output signal 345 of FIG. 4.

With reference now to FIGS. 7-9 exemplary methods according to exemplary embodiments of the present disclosure will now be discussed in detail. FIG. 7 illustrates one exemplary method 600 according to aspects of the disclosed embodiments. At 610, the method 600 detects a feedback signal associated with a induction heating apparatus. The feedback signal provides an indication of the signal flow, such as current flow, through an induction heating coil of the induction heating apparatus. For instance, a feedback signal can be detected across a shunt resistor in a return path of the induction heating coil as discussed above with reference to FIG. 4.

At 620, the method 600 compares the feedback signal with a reference signal to generate an output signal having a duty cycle. The reference signal can be a fixed reference signal or an adjustable reference signal. The duty cycle of the output signal is based at least in part on a percentage of the feedback signal that is greater or less than the reference signal for one period of the feedback signal. Exemplary output signals are illustrated in FIGS. 10-13. As depicted in FIGS. 10-13, the duty cycle of the output signals corresponds to the proximity of the operating frequency of the induction heating apparatus to resonance.

At 630, the method 600 controls the induction heating apparatus based at least in part on the duty cycle of the output signal. For instance, in a particular embodiment, controlling the induction heating apparatus can include adjusting the operating frequency of the induction heating apparatus to achieve a desired power level. The duty cycle of the output signal can be monitored to ensure that the induction heating apparatus is operated at or above resonance.

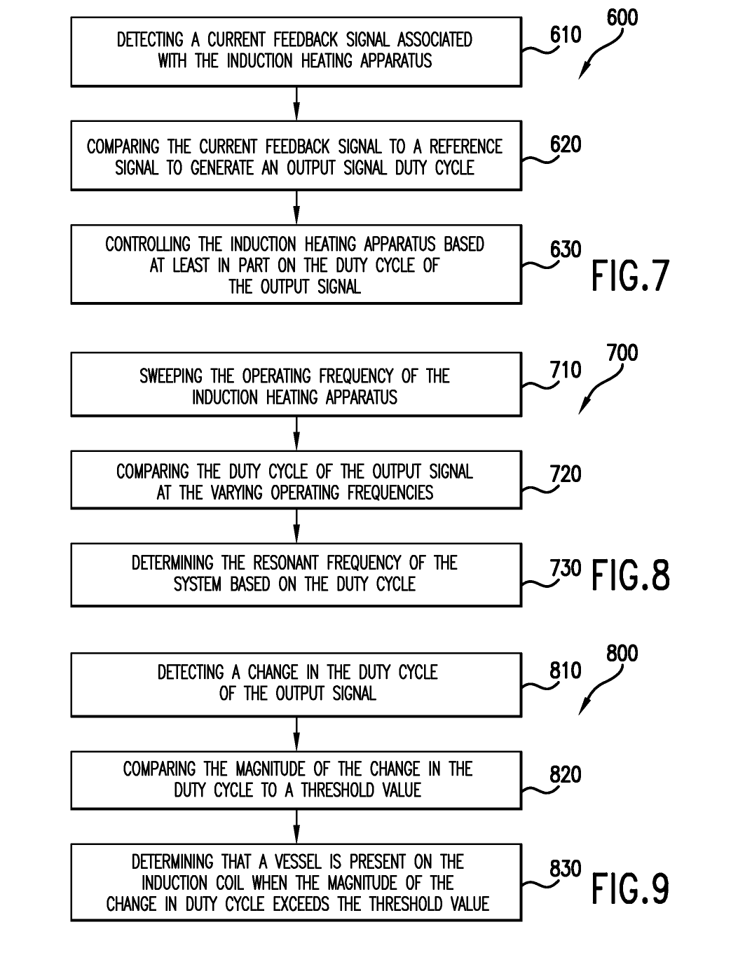

FIG. 8 depicts an exemplary control method 700 according to an exemplary embodiment of the present disclosure. At 710, the method 700 sweeps the operating frequency of the induction heating apparatus from a first frequency to a second frequency. For instance, the method 700 can sweep the operating frequency from 50 kHz to 45 kHz. At 720, the method 700 can compare the duty cycle of the output signal at the first operating frequency to the duty cycle of the output signal at the second operating frequency. At 730, the method 700 can determine the resonant frequency of the system based on a change in the duty cycle at the first operating frequency when compared to the second operating frequency. For instance, if the duty cycle decreases as the operating frequency is shifted from the first frequency to a second lower frequency, the induction heating apparatus is operating above resonance. If the duty cycle increases as the operating frequency is shifted from the first frequency to a second lower frequency, the induction heating apparatus is operating below resonance. If the duty cycle is reduced to substantially zero as the first frequency is shifted to a second frequency, the second frequency is close to the resonant frequency of the induction heating apparatus.

FIG. 9 depicts another exemplary control method 800 according to an exemplary embodiment of the present disclosure. The exemplary method 800 can be used for vessel presence detection on an induction heating coil. At 810, the method 800 detects a change in the duty cycle of the output signal. At 820, the magnitude of the change in duty cycle is compared to a threshold value. At 830, the method 800 determines that a vessel is present on the induction coil when the magnitude of the change in duty cycle exceeds a threshold value.

For instance, FIG. 10 depicts an output signal 910 for an induction heating apparatus operated at 50 kHz with no vessel present on the induction heating coil. The output signal 910 has a duty cycle of 50%. FIG. 11 depicts an output signal 920 for an induction heating apparatus operated at 50 kHz with a vessel present on the induction heating coil. The output signal 920 has a duty cycle of approximately 24%. The magnitude of change in the duty cycle from output signal 910 to output signal 920 is about 26%. If 26% exceeds a predefined threshold value, the change in duty cycle indicates the presence of a vessel on the induction heating coil.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An induction heating system, comprising:
an induction heating coil operable to inductively heat a load with a magnetic field;
a power supply circuit configured to supply a power signal to said induction heating coil at an operating frequency; and
a detector circuit configured to detect a feedback signal corresponding to a signal flowing through said induction heating coil, said detector circuit providing an output signal having a duty cycle, said duty cycle of the output signal being based at least in part on a percentage of the feedback signal that is greater or less than a reference signal;
wherein the duty cycle of the output signal corresponds to the proximity of the operating frequency to resonance of said induction heating system.

2. The induction heating system of claim 1, wherein said detector circuit comprises a shunt resistor in a path of the signal flowing through said induction heating coil, said feedback signal comprising a voltage across said shunt resistor.

3. The induction heating system of claim 1, wherein said detector circuit comprises an amplifier configured to amplify the feedback signal.

4. The induction heating system of claim 2, wherein said detector circuit further comprises a comparator configured to compare the feedback signal to the reference signal, the output of said comparator comprising the output signal of said detector circuit.

5. The induction heating system of claim 1, wherein said reference signal is an adjustable reference signal.

6. The induction heating system of claim 1, wherein said output signal of said detector circuit is provided to a controller, said controller configured to control said power supply circuit based at least in part on the duty cycle of said output signal.

7. The induction heating system of claim 6, wherein said controller is configured to adjust the operating frequency of said power supply circuit based at least in part on the duty cycle of said output signal.

8. The induction heating system of claim 6, wherein said controller is configured to:
sweep the operating frequency of said power supply circuit from a first frequency to a second frequency;
compare the duty cycle of the output signal at the first frequency to the duty cycle of the output signal at the second frequency; and
determine the resonant frequency of the system based on the duty cycle of the output signal.

9. The induction heating system of claim 6, wherein said controller is configured to:
detect a change in the duty cycle of the output signal;
compare the magnitude of the change in the duty cycle to a threshold value;
determine that a vessel is present on said induction heating coil when the magnitude of the change in the duty cycle exceeds the threshold value.

10. The system of claim 1, wherein said power supply circuit comprises a resonant inverter circuit.

11. A method comprising:
detecting a feedback signal in an induction heating apparatus, the feedback signal corresponding to a signal flow through an induction heating coil of the induction heating apparatus; and
comparing the feedback signal to a reference signal to generate an output signal having a duty cycle, the duty cycle of the output signal being based at least in part on a percentage of the feedback signal that is greater or less than the reference signal;
wherein the duty cycle of the output signal corresponds to the proximity of an operating frequency of the induction heating apparatus to resonance.

12. The method of claim 10, wherein the feedback signal comprises a voltage across a shunt resistor in a path of the signal flowing through the induction heating coil.

13. The method of claim 10, wherein the reference signal is an adjustable reference signal.

14. The method of claim 10, wherein the method further comprises controlling the induction heating apparatus based at least in part on the duty cycle of the output signal.

15. The method of claim 14, wherein controlling the induction heating apparatus comprises adjusting the operating frequency of the induction heating apparatus based at least in part on the duty cycle of the output signal.

16. The method of claim 14, wherein controlling the induction heating apparatus comprises:
sweeping the operating frequency induction heating apparatus from a first frequency to a second frequency;
comparing the duty cycle of the output signal at the first frequency to the duty cycle of the output signal at the second frequency; and
determining the resonant frequency of the system based on the duty cycle of the output signal.

17. The method of claim 16, wherein the method comprises setting an operating frequency of the induction heating apparatus to a frequency that is equal to or above the resonant frequency.

18. The method of claim 14, wherein controlling the induction heating apparatus comprises:
detecting a change in the duty cycle of the output signal;
comparing the magnitude of the change in the duty cycle to a threshold value; and
determining that a vessel is present on the induction heating coil when the magnitude of the change in the duty cycle exceeds the threshold value.

19. An induction heating system, comprising
induction heating coil operable to inductively heat a load with a magnetic field;
an inverter circuit configured to supply a chopped DC power signal to said induction heating coil at an operating frequency, said inverter circuit comprising a plurality of switching devices configured to control the direction of current through said induction heating coil; and
a detector circuit configured to detect a feedback signal corresponding to a current flowing through said induction heating coil, said detector circuit providing an output signal having a duty cycle, said duty cycle of said output signal being based at least in part on a percentage of the feedback signal that is greater or less than a reference signal; and
a controller configured to control said inverter circuit based at least in part on the duty cycle of the output signal of said detector circuit.

20. The system of claim 19, wherein said controller controls the switching devices of said inverter circuit based at least in part on the output signal of said detector circuit.
